(19) United States
(12) Patent Application Publication
(10) Pub. No.: US 2018/0297453 A1
(43) Pub. Date: Oct. 18, 2018

(54) SUN VISOR EXTENDER

(71) Applicant: Mark Worden, Shippensburg, PA (US)

(72) Inventor: Mark Worden, Shippensburg, PA (US)

(21) Appl. No.: 15/954,423

(22) Filed: Apr. 16, 2018

Related U.S. Application Data
(60) Provisional application No. 62/486,718, filed on Apr. 18, 2017.

(51) Int. Cl. B60J 3/02

(52) U.S. Cl. CPC B60J 3/0208; B60J 3/0282; B60J 3/0239

(57) ABSTRACT

A sun visor extender structured and arranged to clip on to a vehicle's existing visor structured and arranged to block the sun in two directions while allowing a user to have an adjustable visor along both windows when needed which also will folds up out of the way when not needed.

### CROSS-REFERENCE TO RELATED APPLICATION

The present application is related to and claims priority from prior provisional application Ser. No. 62/486,718 filed Apr. 18, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of car accessory devices and more specifically relates to a sun visor extender structured and arranged to clip on to a vehicle's existing visor structured and arranged to block the sun in two directions while allowing a user to have an adjustable visor along both windows when needed which also will folds up out of the way when not needed.

### 2. Description of the Related Art

Nothing's better than driving on a sunny day on your get away. Heaven is rolling the window down and feeling the breeze which makes you feel at ease. But sometimes those bright sun rays can ruin the relation.

A sun visor is a component of an automobile located on the interior just above the windshield. They are designed with a hinged flap that is adjustable to help shade the eyes of drivers and passengers from the glare of sunlight. The standard sun visor shields some light but the constant repositioning is an inconvenience. Further, adjusting a visor while driving can be a dangerous distraction that takes your mind off of the road action.

Often while driving when the sun is low in the sky, the position of the sun relative to the vehicle changes from the front window to the side window, requiring continuous adjustment of the sun visor to block the blinding rays of the sun. Repositioning the sun visor while driving is distracting and can be a danger to the driver and passengers. Ideally, one device could be used to block the sun from both directions.

Ideally, a sun visor extender should be user-friendly and safe in-use and yet should operate reliably and be manufactured at a modest expense. Thus, a need exists for a sun visor extender structured and arranged to clip on to a vehicle's existing visor structured and arranged to block the sun in two directions while allowing a user to have an adjustable visor along both windows when needed which also will folds up out of the way when not needed and to avoid the above-mentioned problems.

### BRIEF SUMMARY OF THE INVENTION

In view of the foregoing disadvantages inherent in the known car accessory art, the present invention provides a sun visor extender. The general purpose of the present invention, which will be described subsequently in greater detail is to provide a sun visor extender structured and arranged to clip on to a vehicle's existing visor structured and arranged to block the sun in two directions while allowing a user to have an adjustable visor along both windows when needed which also will folds up out of the way when not needed.

A sun visor extender comprising: a main panel including a hollow interior portion and a connector member; and a movable panel. Wherein the connector member is attached to an edge portion of said main panel and is adapted to releasably attach said main panel to a sun visor of a vehicle. Wherein the movable panel is adapted to slide in and out of said hollow interior portion of said main panel. Wherein the main panel and the movable panel are adapted to extend the sun blocking area of the sun visor.

A combination of a sun visor for a vehicle and a sun visor extender is also disclosed, the combination includes: a sun visor including a main sun blocking panel and a pivot member; and a sun visor extender. Wherein the main sun blocking panel is adapted to be pivotally connected to a vehicle in proximity to a window of the vehicle. Wherein the pivot member is attached to an edge portion of said main sun blocking panel and is adapted to releasably attach to a vehicle in proximity to a window member therein, to thereby allow the main sun blocking panel to pivot when connected to the vehicle in proximity to a window of the vehicle.

The present invention holds significant improvements and serves as a sun visor extender. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Sun Visor Extender, constructed and operative according to the teachings of the present invention.

FIG. 1 shows a perspective view illustrating a Sun Visor Extender in a closed position according to an embodiment of the present invention.

FIG. 2A shows a perspective view illustrating a Sun Visor Extender in an open condition according to an embodiment of the present invention.

FIG. 2B shows a perspective view illustrating a Sun Visor Extender in an extended position according to an embodiment of the present invention.

FIG. 3 shows a perspective view illustrating a 2-axis joint of the Sun Visor

Extender according to an embodiment of the present invention.

FIG. 4 shows a perspective view illustrating the Sun Visor Extender rotated at a first angle according to an embodiment of the present invention.

FIG. 5 shows a perspective view illustrating the Sun Visor Extender rotated at a second angle according to an embodiment of the present invention.

FIG. 6 is a perspective view illustrating a combination of a sun visor for a vehicle and a sun visor extender according to an embodiment of the present invention of FIG. 1.

FIG. 7 is another perspective view illustrating the combination of a sun visor for a vehicle and a sun visor extender on both a driver's side and passenger's side of a vehicle according to an embodiment of the present invention of FIG. 1.

FIG. 8 is a perspective view illustrating a combination of a sun visor for a vehicle and a sun visor extender in an in-use condition in a vehicle according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a car accessory device and more specifically relates to a sun visor extender structured and arranged to clip on to a vehicle's existing visor structured and arranged to block the sun in two directions while allowing a user to have an adjustable visor along both windows when needed which also will folds up out of the way when not needed.

Generally speaking, the sun visor extender. The sun visor extender uses tension clips to slip onto the existing original equipment manufacturer (OEM) sun visor in the vehicle. The sun visor extender incorporates a main body, a visor, and a joint. The main body is attached to the OEM sun visor by the tension clips, while the visor is attached to the main body by the joint. The join allows the visor to be rotated along 2 axes so that the visor can be moved across the side window and match the angle of the side window while still allowing the OEM sun visor angle to be adjusted according to the user's preference. The sun visor extender also features a sliding tab to cover the broader area of the side window and a vanity mirror so the user can use the feature that is often found on standard visors but may be hampered by the installation of the sun visor extender. The sliding tab linearly extends from the visor to cover a greater area of the side window. Meanwhile, the vanity mirror is integrated into the main body. The nature of the sun visor extender is such that it can be rotated 180 degrees and installed on the passenger side as well, allowing one design to serve both sides of the vehicle.

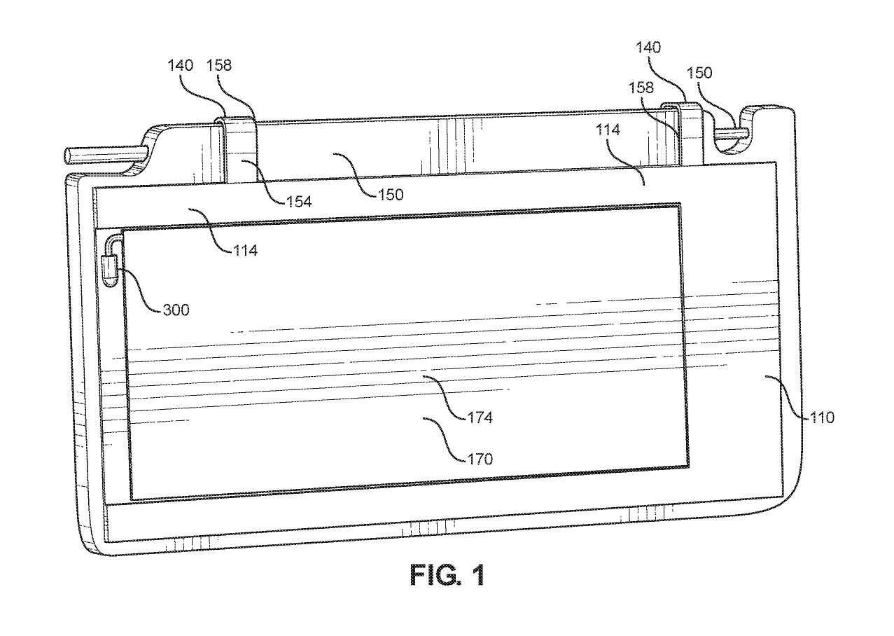

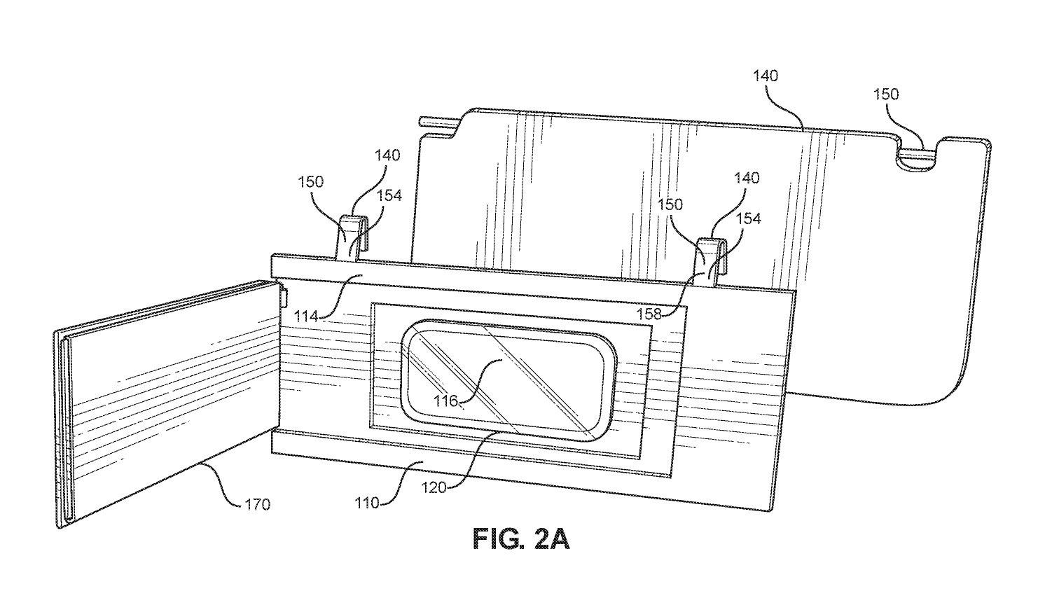

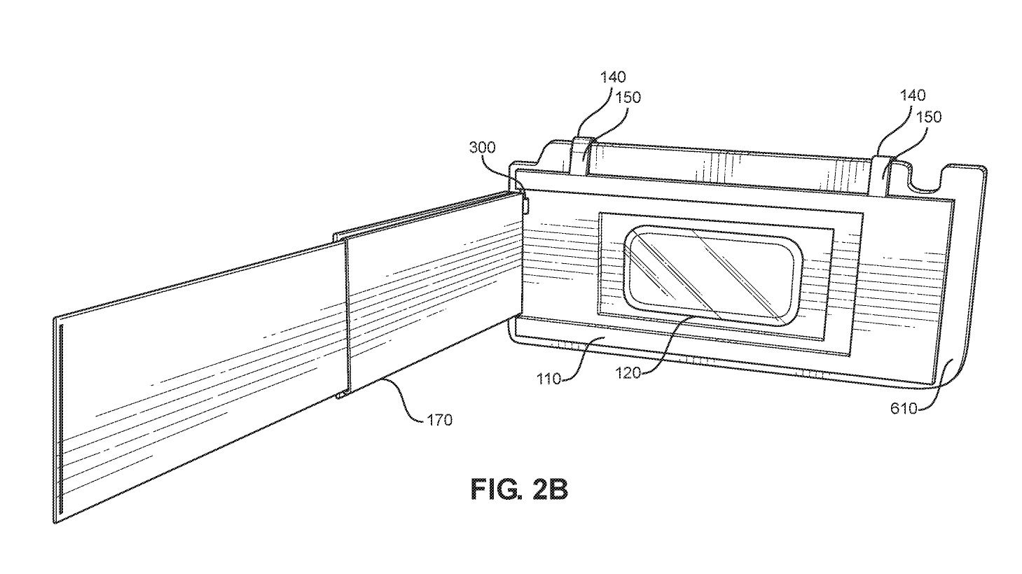

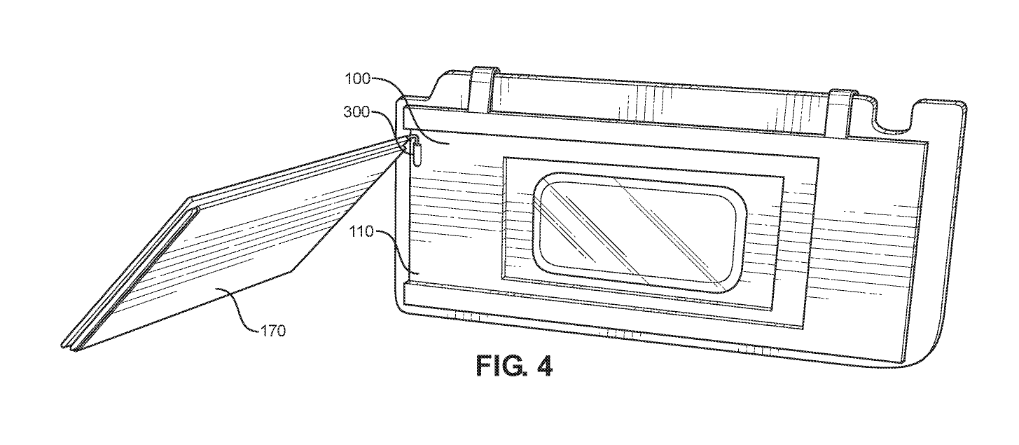

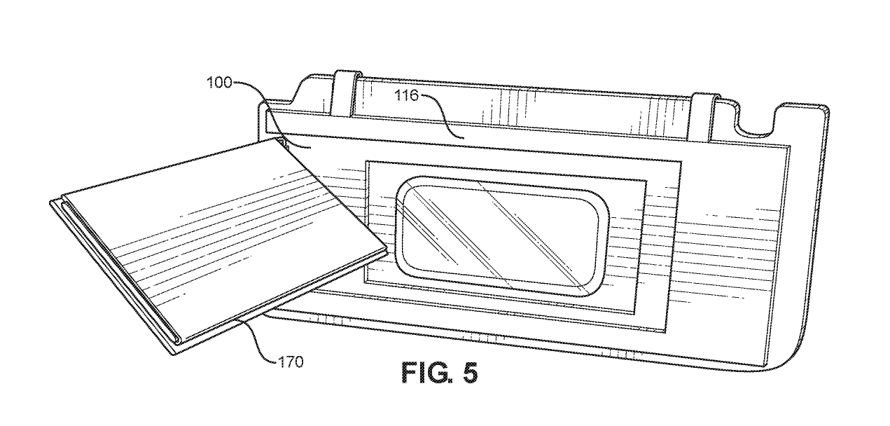

Referring now to FIGS. 1-5, showing perspective views illustrating sun visor extender 100 according to an embodiment of the present invention of FIG. 1.

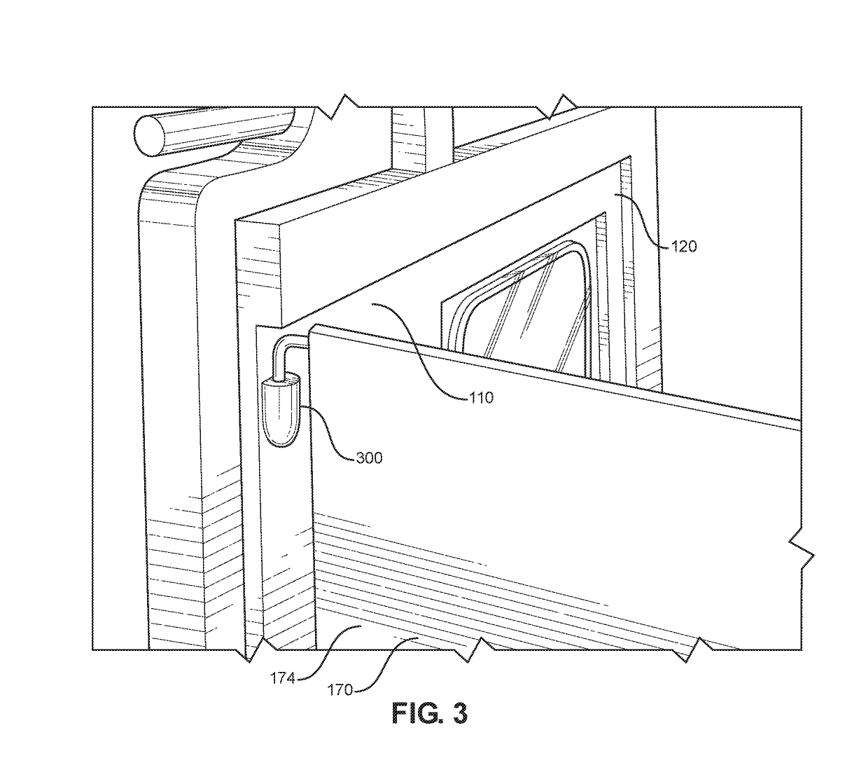

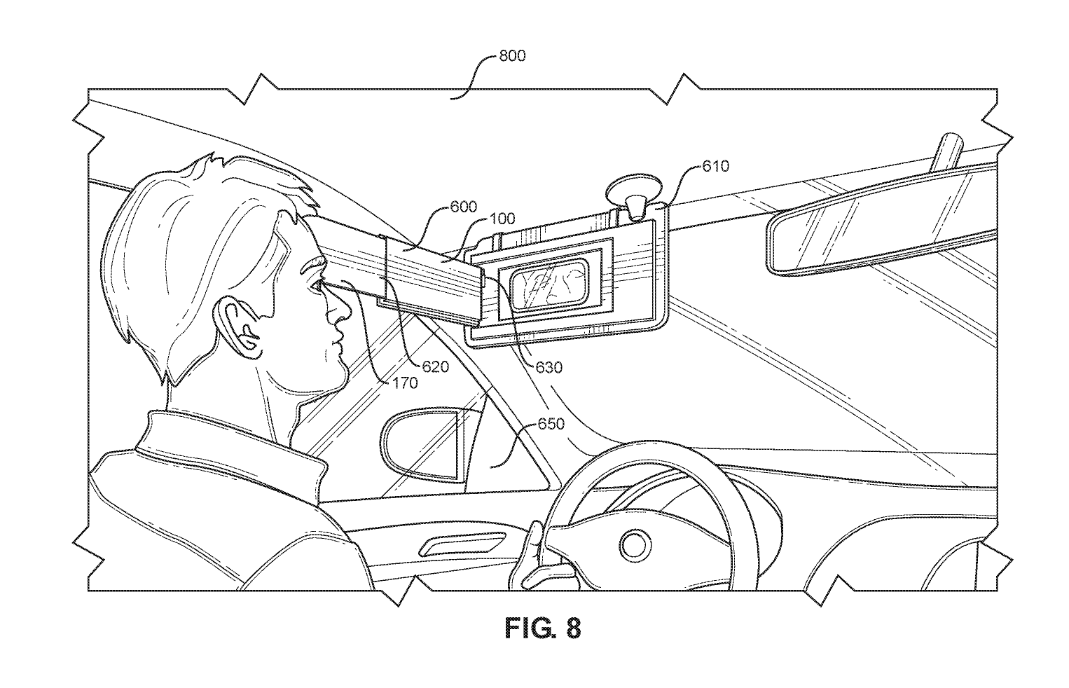

Sun visor extender 100 is disclosed herein in a preferred embodiment comprising: main panel 110 including hollow interior portion 120 and connector member 140; and movable panel 170. Wherein connector member 140 is attached to edge portion 114 of main panel 110 and is adapted to releasably attach main panel 110 to sun visor 610 of vehicle 650. Wherein connector member 140 is formed as clip member 150. Wherein clip member 150 includes spring member 154 thereby forming compression clip 158. Wherein clip member 100 is formed from a flexible plastic material thereby forming compression clip 158. Wherein connector member 140 is formed as pivot pin 300 adapted to be pivotally attached to sun visor 610, and is adapted to allow main panel 110 and movable panel 170 to pivot relative to sun visor 610 as shown in FIGS. 3-5

Wherein movable panel 170 is adapted to slide in and out of hollow interior portion 120 of main panel 110. Wherein main panel 110 and movable panel 170 are adapted to extend the sun blocking area of sun visor 610 as shown in in-use condition 800 of FIG. 8. Wherein main panel 110 further includes mirror member 116 on an outer surface thereof. Wherein movable panel 170 further includes mirror member 174 on an outer surface thereof.

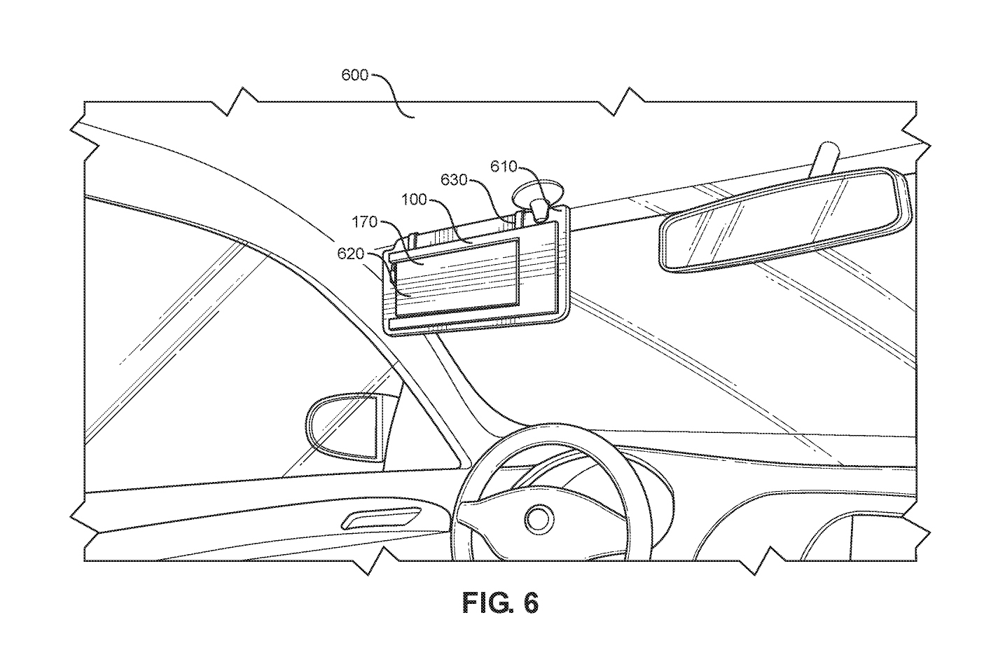

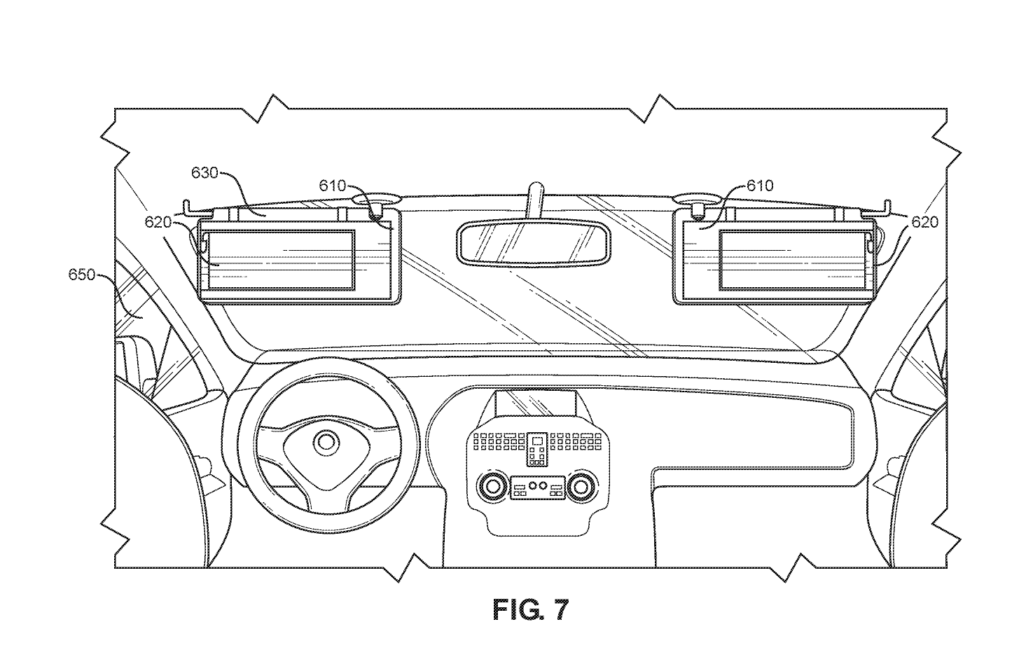

Referring now to FIGS. 6-8 showing perspective views illustrating combination 600 of sun visor 610 for vehicle 650 and sun visor extender 100 according to an embodiment of the present invention of FIG. 1.

Combination 600 of sun visor 610 for vehicle 650 and sun visor extender 100 is also disclosed, combination 600 includes: sun visor 610 including main sun blocking panel 620 and pivot member 630; and sun visor extender 100. Wherein main sun blocking panel 620 is adapted to be pivotally connected to vehicle 650 in proximity to window 654 vehicle 650. Wherein pivot member 630 is attached to an edge portion of main sun blocking panel 620 and is adapted to releasably attach to vehicle 650 in proximity to window member 654 therein, to thereby allow main sun blocking panel 620 to pivot when connected to vehicle 650 in proximity to window 654 of vehicle 650.

In an alternative embodiment, the present invention is designed as an Original Equipment Manufacture (OEM) combination 600 of sun visor 610 for vehicle 650 and sun visor extender 100 in one. As such, connector member 140 is not included and main sun blocking panel 620 is connected directly to a roof of vehicle 650. Main sun blocking panel 620 is pivotally connected to the roof, allowing the present invention to extend from the roof and retracted to a flat position via a double-pivot mount for example.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A sun visor extender comprising:
a main panel including:
a hollow interior portion; and
a connector member;
wherein said connector member is attached to an edge portion of said main panel and is adapted to releasably attach said main panel to a sun visor of a vehicle;
a movable panel;
wherein said movable panel is adapted to slide in and out of said hollow interior portion of said main panel;
wherein said main panel and said movable panel are adapted to extend the sun blocking area of said sun visor.

2. The sun visor extender of claim 1, wherein said connector member is formed as a clip member.

3. The sun visor extender of claim 2, wherein said clip member includes a spring member thereby forming a compression clip.

4. The sun visor extender of claim 2, wherein said clip member is formed from a flexible plastic material thereby forming a compression clip.

5. The sun visor extender of claim 1, wherein said connector member is formed as a pivot pin adapted to be pivotally attached to said sun visor, and is adapted to allow said main panel and said movable panel to pivot relative to said sun visor.

6. The sun visor extender of claim 1, wherein said main panel further includes a mirror member on an outer surface thereof.

7. The sun visor extender of claim 6, wherein said movable panel further includes a mirror member on an outer surface thereof.

8. A combination of a sun visor for a vehicle and a sun visor extender, said combination including:
a sun visor including:
a main sun blocking panel;
wherein said main sun blocking panel is adapted to be pivotally connected to a vehicle in proximity to a window of said vehicle; and
a pivot member;
wherein said pivot member is attached to an edge portion of said main sun blocking panel and is adapted to releasably attach to a vehicle in proximity to a window member therein, to thereby allow said main sun blocking panel to pivot when connected to said vehicle in proximity to a window of said vehicle; and
a sun visor extender comprising:
a main panel including:
a hollow interior portion; and
a connector member;
wherein said connector member is attached to an edge portion of said main panel and is adapted to releasably attach to said sun visor;
a movable panel;
wherein said movable panel is adapted to slide in and out of said hollow interior portion of said main panel;
wherein said main panel and said movable panel are adapted to extend the sun blocking area of said sun visor.

9. The combination of claim 8, wherein said connector member is formed as a clip member.

10. The combination of claim 9, wherein said clip member includes a spring member thereby forming a compression clip.

11. The combination of claim 9, wherein said clip member is formed from a flexible plastic material thereby forming a compression clip.

12. The combination of claim 8, wherein said connector member is formed as a pivot pin adapted to be pivotally attached to said main sun blocking panel of said sun visor, and is adapted to allow said main panel and said movable panel to pivot relative to said sun visor.

13. The combination of claim 8, wherein said main panel further includes a mirror member on an outer surface thereof.

14. The combination of claim 13, wherein said movable panel further includes a mirror member on an outer surface thereof.
